(19) United States
(12) Patent Application Publication
(10) Pub. No.: US 2025/0007663 A1
(43) Pub. Date: Jan. 2, 2025

(54) Signal Sending Method and Apparatus, Signal Receiving Method and Apparatus, and Storage Medium

(71) Applicant: ZTE Corporation, Shenzhen (CN)

(72) Inventors: Haigang HE, Shenzhen (CN); Youxiong LU, Shenzhen (CN); Jie CHEN, Shenzhen (CN); Junpeng LOU, Shenzhen (CN)

(21) Appl. No.: 18/704,764

(22) PCT Filed: Oct. 19, 2022
(86) PCT No.: PCT/CN2022/126271

§ 371 Date: Apr. 25, 2024

(30) Foreign Application Priority Data
Oct. 27, 2021 (CN) 202111257154.5

(51) Int. Cl. H04L 5/00

(52) U.S. Cl. CPC H04L 5/0048; H04L 5/0007

(57) ABSTRACT

Provided are a signal sending method and apparatus, a signal receiving method and apparatus, and a storage medium and an electronic apparatus. The sending method includes: a first communication node generating a target reference signal sequence of target reference signals, where the target reference signal sequence is generated by a pseudo-random sequence, the pseudo-random sequence is a sequence that has been initialized by using a target formula, and the target formula includes resource numbers of the target reference signals; and the first communication node sending the target reference signals, where the target reference signals are formed after the target reference signal sequence is mapped to time-frequency resources.

### CROSS-REFERENCE TO RELATED APPLICATION

This disclosure is a national stage filing under 35 U.S.C. § 371 of international application number PCT/CN2022/126271, filed Oct. 19, 2022, which claims priority to Chinese Patent Application No. CN202111257154.5 filed on Oct. 27, 2021, the disclosure of which is hereby incorporated by reference in its entirety.

### TECHNICAL FIELD

The present disclosure relates to the field of communications, and specifically to a signal sending method and apparatus, a signal receiving method and apparatus, and a storage medium and an electronic apparatus.

### BACKGROUND

In a communication system in the related art, service transmission may be directly performed between communication nodes. For example, in a sidelink communication system, when services need to be transmitted between User Equipment (UE), the services between the UE do not pass through a network side, i.e., are not forwarded over a cellular link between the UE and a base station but are transmitted to target UE by data source UE through a sidelink. This mode of direct communication between the UE has characteristics that are clearly different from traditional cellular system communication modes.

A 5G communication system is used as an example for description below. In 5G NR Uu positioning, an anchor point node is generally a base station. In sidelink positioning, an anchor point node and a target node both are terminals. For 5G NR Uu positioning, a plurality of reference signal (e.g. Positioning Reference Signal (PRS)) resources are supported to use different reference signal sequences. Using the PRS as an example, a sequence Identification (ID) of a PRS sequence for generating different PRS resources is obtained through high-layer parameter configuration of the network side. Likewise, in sidelink positioning, a design principle that the plurality of PRS resources use different PRS sequences may also be supported. However, if the high-layer parameter configuration of the network side in 5G NR Uu positioning is followed to be used to generate sequence IDs of different PRS sequences, there may be some problems. The main problem is that the target UE does not know a sequence ID that is configured by a network for anchor point UE. One method is that an anchor point notifies the sequence IDs of different PRS sequences configured by the network to the target UE, however, which introduces a large additional overhead.

In view of the problem of large signaling overheads in the related art, no effective solution has been proposed yet.

### SUMMARY

Embodiments of the present disclosure provide a signal sending method and apparatus, a signal receiving method and apparatus, and a storage medium and an electronic apparatus, to at least solve the problem of large signaling overheads in the related art.

An embodiment of the present disclosure provides a signal sending method, including: a first communication node generating a target reference signal sequence of target reference signals, where the target reference signal sequence is generated by a pseudo-random sequence, the pseudo-random sequence is a sequence that has been initialized by using a target formula, and the target formula includes resource numbers of the target reference signals; and the first communication node sending the target reference signals. The target reference signals are formed after the target reference signal sequence is mapped to time-frequency resources.

Another embodiment of the present disclosure further provides a signal receiving method, including: a second communication node receiving a target reference signal sent by a first communication node, where the target reference signal is formed after a target reference signal sequence is mapped to a time-frequency resource, the target reference signal sequence is generated by a pseudo-random sequence, the pseudo-random sequence is a sequence that has been initialized by using a target formula, and the target formula includes a resource number of the target reference signal; and the second communication node determining the pseudo-random sequence and the target reference signal sequence based on the resource number of the target reference signal.

Another embodiment of the present disclosure provides a signal sending apparatus, which is applied to a first communication node and includes: a generation module, configured to generate a target reference signal sequence of target reference signals, where the target reference signal sequence is generated by a pseudo-random sequence, the pseudo-random sequence is a sequence that has been initialized by using a target formula, and the target formula includes resource numbers of the target reference signals; and a sending module, configured to send the target reference signals. The target reference signals are formed after the target reference signal sequence is mapped to time-frequency resources.

Another embodiment of the present disclosure further provides a signal receiving apparatus, which is applied to a second communication node and includes: a receiving module, configured to receive a target reference signal sent by a first communication node, where the target reference signal is formed after a target reference signal sequence is mapped to a time-frequency resource, the target reference signal sequence is generated by a pseudo-random sequence, the pseudo-random sequence is a sequence that has been initialized by using a target formula, and the target formula includes a resource number of the target reference signal; and a determination module, configured to determine the pseudo-random sequence and the target reference signal sequence based on the resource number of the target reference signal.

Still another embodiment of the present disclosure further provides a computer-readable storage medium. The computer-readable storage medium stores a computer program. Steps in any one of the above method embodiments are executed when the computer program is configured to operate.

Still another embodiment of the present disclosure further provides an electronic apparatus. The electronic apparatus includes a memory and a processor. The memory stores a computer program. The processor is configured to operate the computer program to execute steps in any one of the above method embodiments.

### BRIEF DESCRIPTION OF THE DRAWINGS

FIG. 1 is a block diagram of a hardware structure of a mobile terminal of a signal transmission method according to an embodiment of the present disclosure.

FIG. 2 is a flowchart of a signal sending method according to an embodiment of the present disclosure.

FIG. 3 is a flowchart of a signal receiving method according to an embodiment of the present disclosure.

FIG. 4 is a structural block diagram of a signal sending apparatus according to an embodiment of the present disclosure.

FIG. 5 is a structural block diagram of a signal receiving apparatus according to an embodiment of the present disclosure.

### DETAILED DESCRIPTION OF THE EMBODIMENTS

The embodiments of the present disclosure are described below in detail with reference to the drawings and the embodiments.

It is to be noted that terms “first”, “second” and the like in the description, claims and the above-mentioned drawings of the present disclosure are used for distinguishing similar objects rather than describing a specific sequence or a precedence order.

The related technology that may be involved in the present disclosure is first described.

A typical application of a sidelink communication includes a Device-to-Device (D2D) communication and a Vehicle to Everything (V2X) communication. The V2X communication includes Vehicle to Vehicle (V2V), Vehicle to Pedestrian (V2P), and Vehicle to Infrastructure (V2I). For a near field communication user that can apply the sidelink communication, the sidelink communication not only saves radio spectrum resources, but also reduces data transmission pressure on a core network, such that system resource occupation can be reduced, spectrum efficiency of a cellular communication system is improved, communication delay is reduced, and network operating costs are saved to a great extent.

During positioning, a communication node that needs to obtain its own geographic position is known as a target node, and the target node is generally a User Equipment (UE). For the positioning of the target node, the positioning of the target node can only be realized with the help of other communication nodes. These communication nodes are generally known as anchor point nodes. The anchor point node may be a device such as a base station, a terminal, a satellite, or the like. Furthermore, the positioning of the target node generally needs to be realized with the help of a PRS. The PRS here refers to a reference signal for positioning. The communication node for sending the PRS may be the target node, or may also be the anchor point node. The communication node for sending the PRS may be a device such as a base station, a terminal, a satellite, or the like.

Further, positioning may be classified into absolute positioning and relative positioning. In the absolute positioning, a geographic position of the anchor point node is known. Through the measurement of the PRS and the geographic position of the anchor point node, a geographic position of the target node may be deduced. For example, through the measurement of the PRS, signal propagation delay between the target node and the anchor point node may further be obtained, so as to further deduce a distance between the target node and the anchor point node. In this example, the geographic position of the target node may be calculated according to geographic positions of a plurality of anchor point nodes, and distances between the target node and the plurality of anchor points, i.e., the positioning of the target node is obtained.

In the relative positioning, the geographic position of the anchor point node may be known or unknown. Next, the relative positioning is described with an example that the geographic position of the anchor point node is unknown. For example, the anchor point node sends a PRS, and the target node measures the PRS sent by the anchor point node. For example, through the measurement of the PRS, the target node obtains the distance between the anchor point node and the target node, and obtains an angle of arrival of the PRS. Based on the distance between the anchor point node and the target node and the angle of arrival of the PRS that are obtained by the target node, the target node may calculate the distance between the target node and the anchor point node, and obtains a direction of the anchor point node relative to the target node, such that relative positioning information of the target node relative to the anchor point node is obtained.

How the present disclosure solves the problem of large signaling overheads in the related art is described below with reference to embodiments.

The method embodiments provided in the embodiments of the present disclosure may be executed in a mobile terminal, a computer terminal or a similar computing apparatus. By being operated on the mobile terminal as an example, FIG. 1 is a block diagram of a hardware structure of a mobile terminal of a signal transmission method according to an embodiment of the present disclosure. As shown in FIG. 1, the mobile terminal may include one or more (only one is shown in FIG. 1) processors 102 (the processor 102 may include, but is not limited to, a processing apparatus such as a microprocessor MCU or a programmable logic device FPGA) and a memory 104 configured to store data. The above mobile terminal may further include a transmission device 106 configured to achieve a communication function, and an input/output device 108. Those skilled in the art may understand that the structure shown in FIG. 1 is only a schematic diagram, which does not limit the structure of the above mobile terminal. For example, the mobile terminal may also include more or less components than those shown in FIG. 1, or have a different configuration from that shown in FIG. 1.

The memory 104 may be configured to store a computer program, for example, a software program and a module of application software, such as a computer program corresponding to a signal transmission method (including a signal sending method and/or transmission method) in the embodiments of the present disclosure. The processor 102 runs the computer program stored in the memory 104, so as to execute various functional applications and data processing, i.e., to realize the above method. The memory 104 may include a high-speed random access memory, and may further include a non-volatile memory, such as one or more magnetic disk memory apparatuses, a flash memory device, or other non-volatile solid-state memory devices. In some embodiments, the memory 104 may further include memories remotely disposed relative to the processor 102. The remote memories may be connected to the mobile terminal by using a network. Examples of the above network include, but are not limited to, the Internet, an intranet, a local area network, a mobile communication network and a combination thereof.

The transmission apparatus 106 is configured to receive or send data via the network. The specific example of the above network may include a wireless network provided by a communication provider of the mobile terminal. In an example, the transmission apparatus 106 includes a Network Interface Controller (NIC), and may be connected to other network devices by using a base station, so as to communicate with the Internet. In an example, the transmission apparatus 106 is a Radio Frequency (RF) module, which is configured to communicate with the Internet in a wireless manner.

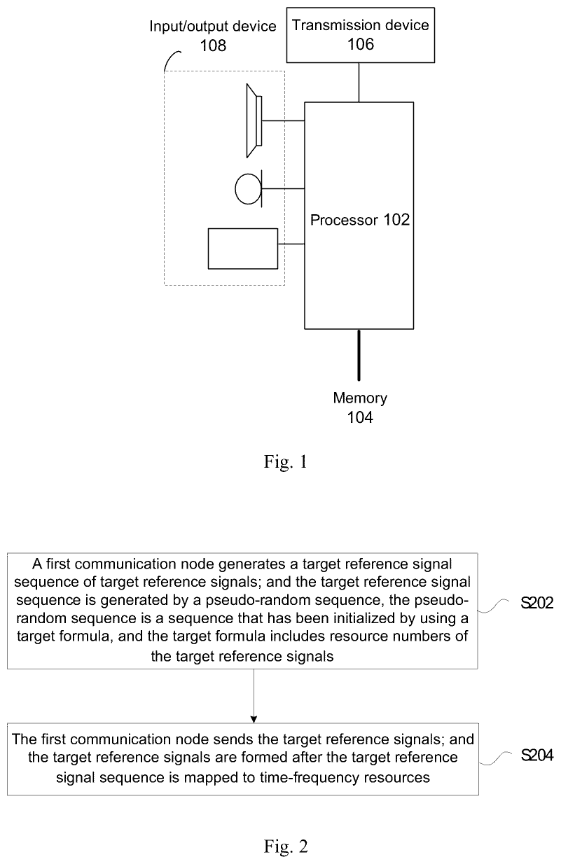

FIG. 2 is a flowchart of a signal sending method according to an embodiment of the present disclosure. As shown in FIG. 2, the flow includes the following steps.

At S202, a first communication node generates a target reference signal sequence of target reference signals; and the target reference signal sequence is generated by a pseudo-random sequence, the pseudo-random sequence is a sequence that has been initialized by using a target formula, and the target formula includes resource numbers of the target reference signals.

At S204, the first communication node sends the target reference signals; and the target reference signals are formed after the target reference signal sequence is mapped to time-frequency resources.

In the above embodiment, the target reference signal sequence is a sequence consisting of a series of modulation symbols. The target reference signals are formed after the target reference signal sequence is mapped to the time-frequency resources. The first communication node May send the target reference signal in a unicast, multicast, broadcast, etc. manner.

An execution subject of the steps is the first communication node. The first communication node may be a terminal device. Furthermore, a node for receiving the target reference signal sent by the first communication node may also be a terminal device.

Through the above embodiment, a formula for generating the target reference signal sequence includes a resource index of the target reference signal, such that a purpose that different reference signal resources use different reference signal sequences is achieved. When a plurality of reference signal resources need to be sent on the plurality of reference signal resources, different reference signal sequences are generated for different reference signal resources through parameters or variables that may be obtained by some sending end without notifying receiving ends through signaling, or the sending ends notify a variable that is the same for a plurality of reference signals, and different reference signal sequences are generated for different reference signal resources through the variable and the parameters or variables that may be obtained by some sending ends without notifying the receiving ends through signaling. Compared to a method of notifying an identifier of each reference signal resource in the related art, by using the solution in the embodiments of the present disclosure, the effect of reducing the sending of resource identifiers and effectively reducing signaling overheads can be achieved, such that the problem of large signaling overheads in the related art is solved.

In an optional embodiment, the target reference signal includes a PRS.

In an optional embodiment, the PRS includes a sidelink PRS.

In an optional embodiment, the target formula includes a product of first data and second data.

The first data includes the resource number, and the second data includes a value that is calculated by Cyclic Redundancy Check (CRC) corresponding to a target channel. In this embodiment, the target channel may be a Physical Sidelink Control Channel (PSCCH). This embodiment is specifically described below with examples.

In this embodiment:

The pseudo-random sequence c(n) is configured to generate a PRS sequence r(m).

The pseudo-random sequence c(n) is initialized by using a formula, i.e., cᵢₙᵢₜ is calculated by using the formula.

The formula for initializing the pseudo-random sequence includes a PRS resource number r, i.e., the formula for cᵢₙᵢₜ calculation includes the PRS resource number r. The resource number here may also be known as a resource index or a resource Identification (ID).

Further, the formula for initializing the pseudo-random sequence includes a product of a first term (corresponding to the first data) and a second term (corresponding to the second data). That is, the formula for cᵢₙᵢₜ calculation includes a product of a first term and a second term.

The first term includes the PRS resource number r.

The second term includes the value calculated by the CRC of the PSCCH, labeled as N_{ID}^{X}.

The formula for cᵢₙᵢₜ calculation including the product of the first term and the second term is implemented as follows. The formula for cᵢₙᵢₜ calculation includes a variable n_{ID,seq}^{PRS}, a formula for N_{ID,seq}^{PRS} calculation includes a product of a first term and a second term; and the first term includes the PRS resource number r, and the second term includes the value N_{ID}^{X} calculated by the CRC of the PSCCH.

The above description provides an overview of this embodiment, and specific examples of this embodiment are then given based on the above description.

A universal pseudo-random sequence is defined by a length-31Gold sequence. A length is an output sequence c(n) of M_{PN}, which is defined by the following when n=0,1, . . . ,M_{PN}−1.

$$\begin{matrix}c ( n ) = ( {x}_{1} ( n + {N}_{C} ) + {x}_{2} ( n + {N}_{C} ) ) mod 2 \\ {x}_{1} ( n + 31 ) = ( {x}_{1} ( n + 3 ) + {x}_{1} ( n ) ) mod 2 \\ {x}_{2} ( n + 31 ) = ( {x}_{2} ( n + 3 ) + {x}_{2} ( n + 2 ) + {x}_{2} ( n + 1 ) + {x}_{2} ( n ) ) mod 2\end{matrix}$$

N_{C}=1600, and a first m sequence x₁(n) is initialized by using x₁(0)=1,x₁(n)=0,n32 1,2, . . . ,30. Initialization of a second m sequence x₂(n) is represented by cᵢₙᵢₜ=Σᵢ₌₀³⁰ x₂(i)·2ⁱ, and a value depends on the application of the sequence.

UE assumes that a reference signal sequence r(m) is defined by the following formula.

$$r ( m ) = \frac{1}{\sqrt{2}} ( 1 - 2 c ( 2 m ) ) + j \frac{1}{\sqrt{2}} ( 1 - 2 c ( 2 m + 1 ) )$$

The pseudo-random sequence c(n) is defined as described above. A pseudo-random sequence generator should be initialized by using the following formula.

$${c}_{init} = ( {2}^{22} ⌊ \frac{{n}_{ID , seq}^{P R S}}{1024} ⌋ + {2}^{10} ( {N}_{s y m b}^{slot} {n}_{s , f}^{μ} + 1 + 1 ) ( 2 ( {n}_{I D , seq}^{P R S} mod 1024 ) + 1 ) + ( {n}_{I D , s e q}^{P R S} mod 1024 ) ) mod {2}^{31}$$

l is the number of symbols of OFDM within a timeslot, and n_{s,f}^{μ} is the number of timeslots within a frame.

In this embodiment, the formula for initializing the pseudo-random sequence includes a product of a first term and a second term. That is, the formula for cᵢₙᵢₜ calculation includes a product of a first term and a second term. More specifically, the formula for cᵢₙᵢₜ calculation includes the variable n_{ID,seq}^{PRS}, and the formula for variable n_{ID,seq}^{PRS} calculation includes a product of a first term and a second term, and n_{ID,seq}^{PRS}=((r+1)N_{ID}^{X}) mod 2¹⁶, or n_{ID,seq}^{PRS}=(r+1)(N_{ID}^{X} mod 2¹⁶).

For n_{ID,seq}^{PRS}=((r+1)N_{ID}^{X}) mod 2¹⁶, calculation for n_{ID,seq}^{PRS} includes a product of a first term r+1 and a second term N. The first term (r+1) includes the PRS resource number r, and the second term N_{ID}^{X} includes N_{ID}^{X}.

For n_{ID,seq}^{PRS}=(r+1)(N_{ID}^{X} mod 2¹⁶), calculation for n_{ID,seq}^{PRS} includes a product of a first term r+1 and a second term (N_{ID}^{X} mod 2¹⁶). The first term r+1 includes the PRS resource number r, and the second term (N_{ID}^{X} mod 2¹⁶) includes N_{ID}^{X}.

N_{ID}^{X} is equal to a decimal of the CRC corresponding to the PSCCH, i.e. N_{ID}^{X}Σᵢ₌₀^{L-1}pᵢ·2^{L-1-i}. A bit of an effective load is represented as a₀, a₁, a₂, a₃, . . . , a_{A-31 1}, and a parity bit is represented as p₀, p₁, p₂, p₃, . . . , p_{L-1}, where A is the size of the effective load, and L is the number of parity bits.

After a first terminal (corresponding to the first communication node) generates the PRS sequence according to the above method, the first terminal sends the PRS, and the PRS is formed after the PRS sequence is mapped to a time-frequency resource.

A second terminal receives the PRS sent by the first terminal.

In an optional embodiment, the target formula includes a sum of first data and second data. The first data includes the resource number, and the second data includes a value that is calculated by CRC corresponding to a target channel. This embodiment is specifically described below with examples.

In this embodiment:
the pseudo-random sequence c(n) is configured to generate a PRS sequence r (m).

The pseudo-random sequence c(n) is initialized by using a formula, i.e., cᵢₙᵢₜ is calculated by using the formula.

The formula for initializing the pseudo-random sequence includes the PRS resource number r, i.e., the formula for cᵢₙᵢₜ calculation includes the PRS resource number r. The resource number here may also be known as a resource index or a resource ID.

Further, the formula for initializing the pseudo-random sequence includes a sum of a first term and a second term. That is, the formula for cᵢₙᵢₜ calculation includes a sum of a first term and a second term.

The first term includes the PRS resource number r.

The second term includes the value calculated by the CRC of the PSCCH, labeled as N_{ID}^{X}.

The formula for cᵢₙᵢₜ calculation including the sum of the first term and the second term is implemented as follows. The formula for cᵢₙᵢₜ calculation includes a variable n_{ID,seq}^{PRS}, a formula for n_{ID,seq}^{PRS} calculation includes a sum of a first term and a second term; and the first term includes the PRS resource number r, and the second term includes the value N_{ID}^{X} calculated by the CRC of the PSCCH.

The above description provides an overview of this embodiment, and specific examples of this embodiment are then given based on the above description.

A universal pseudo-random sequence is defined by a length-31Gold sequence. A length is an output sequence c(n) of M_{PN}, which is defined by the following when n=0,1, . . . ,M_{PN}−1.

$$\begin{matrix}c ( n ) = ( {x}_{1} ( n + {N}_{C} ) + {x}_{2} ( n + {N}_{C} ) ) mod 2 \\ {x}_{1} ( n + 31 ) = ( {x}_{1} ( n + 3 ) + {x}_{1} ( n ) ) mod 2 \\ {x}_{2} ( n + 31 ) = ( {x}_{2} ( n + 3 ) + {x}_{2} ( n + 2 ) + {x}_{2} ( n + 1 ) + {x}_{2} ( n ) ) mod 2\end{matrix}$$

N_{C}=1600, and a first m sequence x₁(n) is initialized by using x₁(0)=1, x₁(n)=0,n=1,2, . . . ,30. Initialization of a second m sequence x₂(n) is represented by cᵢₙᵢₜ=Σᵢ₌₀³⁰x₂(i)·2ⁱ, and a value depends on the application of the sequence.

UE assumes that a reference signal sequence r(m) is defined by the following formula.

$$r ( m ) = \frac{1}{\sqrt{2}} ( 1 - 2 c ( 2 m ) ) + j \frac{1}{\sqrt{2}} ( 1 - 2 c ( 2 m + 1 ) )$$

The pseudo-random sequence c(n) is defined as described above. A pseudo-random sequence generator should be initialized by using the following formula.

$${c}_{init} = ( {2}^{22} ⌊ \frac{{n}_{ID , seq}^{PRS}}{1024} ⌋ + {2}^{10} ( {N}_{symb}^{slot} {n}_{s , f}^{μ} + l + 1 ) ( 2 ( {n}_{ID , seq}^{PRS} mod 1024 ) + 1 ) + ( {n}_{ID , seq}^{PRS} mod 1024 ) ) mod {2}^{31}$$

l is the number of symbols of OFDM within a timeslot, and n_{s,f}^{μ}. is the number of timeslots within a frame.

In this embodiment, the formula for initializing the pseudo-random sequence includes a sum of a first term and a second term. That is, the formula for cᵢₙᵢₜ calculation includes a sum of a first term and a second term. More specifically, the formula for cᵢₙᵢₜ calculation includes the variable n_{ID,seq}^{PRS}, and the formula for variable n_{ID,seq}^{PRS} calculation includes a sum of a first term and a second term, and n_{ID,seq}^{PRS}=N_{ID}^{X} mod 2¹⁶+ror n_{ID,seq}^{PRS}=(N_{ID}^{X}+r)mod 2¹⁶.

For n_{ID,seq}^{PRS}=N_{ID}^{X} mod 2¹⁶+r, calculation for n_{ID,seq}^{PRS} includes a sum of a first term r and a second term N_{ID}^{X} mod 2¹⁶. The first term r includes the PRS resource number r, and the second term N_{ID}^{X} mod 2¹⁶ includes N_{ID}^{X}.

For n_{ID,seq}^{PRS} =(N_{ID}^{X}+r)mod 2¹⁶, calculation for n_{ID,seq}^{PRS} includes a sum of a first term r and a second term N_{ID}^{X}. The first term r includes the PRS resource number r, and the second term N_{ID}^{X} includes N_{ID}^{X}.

N_{ID}^{X} is equal to a decimal of the CRC corresponding to the PSCCH, i.e. N_{ID}^{X}=Σᵢ₌₀^{L-1}pᵢ·2^{L-1-i}. A bit of an effective load is represented as a₀, a₁, a₂, a₃, . . . ,a_{A-1}, and a parity bit is represented as p₀, p₁, p₂, p₃, . . . , p_{L-1}, where A is the size of the effective load, and L is the number of parity bits.

After a first terminal generates the PRS sequence according to the above method, the first terminal sends the PRS, and the PRS is formed after the PRS sequence is mapped to a time-frequency resource.

A second terminal receives the PRS sent by the first terminal.

In an optional embodiment, the target formula includes a product of third data, fourth data, and fifth data. The third data includes the following data: a symbol number of OFDM for sending the reference signal, a timeslot number of a timeslot for sending the reference signal, and the number of symbols of OFDM within the timeslot. The fourth data includes a value that is calculated by CRC corresponding to a target channel, or comprises a source ID of the first communication node. The fifth data includes the resource number. In an optional embodiment, the target formula includes the predetermined power of 2. The value of the predetermined power is equal to 10−floor(A/2), where Ath power of 2 minus 1 is equal to a maximum value of the resource number, and floor( ) is a downward rounding function. This embodiment is specifically described below with examples.

In this embodiment:

The pseudo-random sequence c(n) is configured to generate a PRS sequence r(m).

The pseudo-random sequence c(n) is initialized by using a formula, i.e., cᵢₙᵢₜ is calculated by using the formula.

The formula for initializing the pseudo-random sequence includes the PRS resource number r, i.e., the formula for cᵢₙᵢₜ calculation includes the PRS resource number r. The resource number here may also be known as a resource index or a resource ID.

Further, the formula for initializing the pseudo-random sequence includes a product of a first term (corresponding to the third data), a second term (corresponding to the fourth data), and a third term (corresponding to the fifth data). That is, the formula for cᵢₙᵢₜ calculation includes a product of a first term, a second term, and a third term.

The first term includes the number of symbols of OFDM within a timeslot (i.e., a timeslot for sending a PRS), a timslot number with in a frame (i.e., a frame for sending the PRS), and the number of symbols of OFDM within a timeslot.

The second term includes a value (labeled as N_{ID}^{X}) calculated by the CRC of the PSCCH, or includes a source ID (or known as a terminal ID) of a first terminal.

The third term includes a resource number r.

For example, the resource number corresponds to a resource number of a sidelink PRS. A value range of the resource number r is 0, 1, 2, . . . , 2^{A}−1.

Further, in this embodiment, the formula for initializing the pseudo-random sequence includes a power of 2, and the value of the power is equal to 10−floor(A/2). The value of A meets a restriction that the Ath power of 2 minus 1 is equal to the maximum value of the resource number. The floor( ) represents downward rounding of the content of ( ).

The formula for cᵢₙᵢₜ calculation including the product of the first term, the second term, and the third term is implemented as follows. The formula for cᵢₙᵢₜ calculation includes the product of the first term, the second term, and the third term.

The first term includes the number of symbols of OFDM within the timeslot, the timslot number with in the frame, and the number of symbols of OFDM within the timeslot.

The second term includes the value N_{ID}^{X} calculated by the CRC of the PSCCH.

The second term includes the resource number r.

The above description provides an overview of this embodiment, and specific examples of this embodiment are then given based on the above description.

A universal pseudo-random sequence is defined by a length-31Gold sequence. A length is an output sequence c(n) of M_{PN}, which is defined by the following when n=0,1, . . . ,M_{PN-1}.

$$c ( n ) = ( {x}_{1} ( n + {N}_{C} ) + {x}_{2} ( n + {N}_{C} ) ) mod 2$$

$${x}_{1} ( n + 31 ) = ( {x}_{1} ( n + 3 ) + {x}_{1} ( n ) ) mod 2$$

$${x}_{2} ( n + 31 ) = ( {x}_{2} ( n + 3 ) + {x}_{2} ( n + 2 ) + {x}_{2} ( n + 1 ) + {x}_{2} ( n ) ) mod 2$$

N_{C}=1600, and a first m sequence x₁(n) is initialized by using x₁(0)=1, x₁(n)=0,n=1,2, . . . ,30. Initialization of a second m sequence x₂(n) is represented by cᵢₙᵢₜ=Σᵢ₌₀³⁰x₂(i)·2ⁱ, and a value depends on the application of the sequence.

UE assumes that a reference signal sequence r(m) is defined by the following formula.

$$r ( m ) = \frac{1}{\sqrt{2}} ( 1 - 2 c ( 2 m ) ) + j \frac{1}{\sqrt{2}} ( 1 - 2 c ( 2 m + 1 ) )$$

The pseudo-random sequence c(n) is defined as described above. A pseudo-random sequence generator should be initialized by using the following formula.

$$( {2}^{22} ⌊ \frac{{n}_{ID , seq}^{PRS}}{{2}^{10 - floor ( \frac{A}{2} )}} ⌋ + {2}^{10} ( {N}_{symb}^{slot} {n}_{s , f}^{μ} + l + 1 ) ( 2 ( {n}_{ID , seq}^{PRS} mod {2}^{10 - floor ( \frac{A}{2} )} ) + 1 ) + ( r + 1 ) ( {n}_{ID , seq}^{PRS} mod {2}^{10 - floor ( \frac{A}{2} )} ) ) mod {2}^{31}$$

l is the number of symbols of OFDM within the timeslot, and n_{s,f}^{μ} is the number of timeslots within the frame.

In this embodiment, the formula for initializing the pseudo-random sequence includes the product of the first term, the second term, and the third term. That is, the formula for cᵢₙᵢₜ calculation includes the product of the first term, the second term, and the third term. From the formula for cᵢₙᵢₜ calculation, it may be seen that, the first term included in the formula for cᵢₙᵢₜ calculation is N_{symb}^{slot}n_{s,f}^{μ}+l+1, the second term is

$$( {n}_{ID , seq}^{PRS} mod {2}^{10 - floor ( \frac{A}{2} )} ) + 1 ,$$

and the third term is r+1, as well as n_{ID,seq}^{PRS}=N_{ID}^{X} mod 2¹⁶ in the second term.

N_{ID}^{X} is equal to a decimal of the CRC corresponding to the PSCCH, i.e. N_{ID}^{X}=Σᵢ₌₀^{L-1}pᵢ·2^{L-1-i}. A bit of an effective load is represented as a₀, a₁, a₂, a₃, . . . , a_{A-1}, and a parity bit is represented as p₀, p₁, p₂, p₃, . . ., p_{L-1}, where A is the size of the effective load, and L is the number of parity bits.

The formula for cᵢₙᵢₜ calculation includes 2^{10-floor(A/2)}. The value of A in the power 10−floor(A/2) of 2 meets a restriction that the Ath power of 2 minus 1 is equal to the maximum value of the resource number.

After the first terminal generates the PRS sequence according to the above method, the first terminal sends the PRS, and the PRS is formed after the PRS sequence is mapped to a time-frequency resource.

A second terminal receives the PRS sent by the first terminal.

In an optional embodiment, the target formula includes a variable related to the resource number. The variable corresponding to the resource number with a value being r is obtained by calculating the variable corresponding to the resource number with a value being r−1, where r is a positive integer. Optionally, the variable corresponding to the resource number with the value being r is calculated as follows. A product of the variable corresponding to the resource number with the value being r−1 and one positive integer is obtained, and then modulo is performed on the other positive integer. Optionally, r≥0, and in a case of r=0, the variable corresponding to the resource number with the value being 0 is calculated through a predetermined formula, and the predetermined formula includes a value that is calculated by CRC corresponding to a target channel. This embodiment is specifically described below with examples.

In this embodiment:
the pseudo-random sequence c(n) is configured to generate a PRS sequence r(m).

The pseudo-random sequence c(n) is initialized by using a formula, i.e., cᵢₙᵢₜ is calculated by using the formula.

The formula for initializing the pseudo-random sequence includes the PRS resource number r, i.e., the formula for cᵢₙᵢₜ calculation includes the PRS resource number r. The resource number here may also be known as a resource index or a resource ID.

Further, a formula for initializing the pseudo-random sequence includes a variable related to the resource number r labeled as n_{ID,seq,r}^{PRS}, such that the variable corresponding to the resource number r−1 is n_{ID,seq,r-1}^{PRS}, and the variable corresponding to the resource number r is n_{ID,seq,r}^{PRS}.

For the positive integer r, the variable n_{ID,seq,r}^{PRS} corresponding to the resource number r is calculated by the variable n_{ID,seq,r-1}^{PRS} corresponding to the resource number r−1. Specifically,

n_{ID,seq,r}^{PRS}=((A·n_{ID,seq,r-1}^{PRS})mod D) mod 2¹⁶

Further, the minimum value of the resource number r is 0. A variable corresponding to the resource number 0 is labeled as n_{ID,seq,r=0}^{PRS}. The value of the variable n_{ID,seq,r=0}^{PRS}corresponding to the resource number 0 is calculated through a formula. The formula includes a value that is calculated by CRC of a PSCCH and is labeled as N_{ID}^{X}.

The above description provides an overview of this embodiment, and specific examples of this embodiment are then given based on the above description.

A universal pseudo-random sequence is defined by a length-31Gold sequence. A length is an output sequence c(n) of M_{PN}, which is defined by the following when n=0,1, . . . ,M_{PN}−1.

$$c ( n ) = ( {x}_{1} ( n + {N}_{C} ) + {x}_{2} ( n + {N}_{C} ) ) mod 2$$

$${x}_{1} ( n + 31 ) = ( {x}_{1} ( n + 3 ) + {x}_{1} ( n ) ) mod 2$$

$${x}_{2} ( n + 31 ) = ( {x}_{2} ( n + 3 ) + {x}_{2} ( n + 2 ) + {x}_{2} ( n + 1 ) + {x}_{2} ( n ) ) mod 2$$

N_{C}=1600, and a first m sequence x₁(n) is initialized by using x₁(0)=1,x₁(n)=0,n=1,2, . . . ,30. Initialization of a second m sequence x₂(n) is represented by cᵢₙᵢₜ=Σᵢ₌₀³⁰x₂(i)·2ⁱ, and a value depends on the application of the sequence.

UE assumes that a reference signal sequence r(m) is defined by the following formula.

$$r ( m ) = \frac{1}{\sqrt{2}} ( 1 - 2 c ( 2 m ) ) + j \frac{1}{\sqrt{2}} ( 1 - 2 c ( 2 m + 1 ) )$$

The pseudo-random sequence c(n) is defined as described above. A pseudo-random sequence generator should be initialized by using the following formula.

$${c}_{init} = ( {2}^{22} ⌊ \frac{{n}_{ID , seq , r}^{PRS}}{1024} ⌋ + {2}^{10} ( {N}_{symb}^{slot} {n}_{s , f}^{μ} + l + 1 ) ( 2 ( {n}_{ID , seq , r}^{PRS} mod 1024 ) + 1 ) + ( {n}_{ID , seq , r}^{PRS} mod 1024 ) ) mod {2}^{31}$$

l is the number of symbols of OFDM within the timeslot, and n_{s,f}^{μ} is the number of timeslots within the frame.

For r is greater than 0, n_{ID,seq,r}^{PRS}=((A·n_{ID,seq,r-1}^{PRS})mod D)mod 2¹⁶. For r is equal to 0, n_{ID,seq,r-0}^{PRS}=N_{ID}^{X}mod 2¹⁶. A and D are positive integers.

N_{ID}^{X} is equal to a decimal of the CRC corresponding to the PSCCH, i.e. N_{ID}^{X}=Σᵢ₌₀^{L-1}pᵢ·2^{L-1-i}. A bit of an effective load is represented as a₀, a₁, a₂, a₃, . . . , a_{A-1}, and a parity bit is represented as p₀, p₁, p₂, p₃, . . ., p_{L-1}, where A is the size of the effective load, and L is the number of parity bits.

After the first terminal generates the PRS sequence according to the above method, the first terminal sends the PRS, and the PRS is formed after the PRS sequence is mapped to a time-frequency resource.

A second terminal receives the PRS sent by the first terminal.

In an optional embodiment, the target formula includes a resource index of the target reference signal and a source ID of the first communication node. Optionally, the target formula includes a product of a resource index of the target reference signal and a predetermined value. Optionally, the target formula includes a product of a target sum obtained by adding the resource index of the target reference signal and 1, and the predetermined value. Optionally, the method further includes the first communication node sending SCI. The SCI includes the predetermined value. Optionally, the predetermined value is a fixed value. Optionally, the predetermined value is a value that is obtained through high-layer configuration and pre-configuration. Optionally, the target formula includes a summation value of a product of a resource index of the target reference signal and a predetermined value and a source ID of the first communication node. Optionally, the target formula includes a summation value of a resource index of the target reference signal and a source ID of the first communication node. This embodiment is specifically described below with examples.

In this embodiment:
the pseudo-random sequence c(n) is configured to generate a PRS sequence r(m).

The pseudo-random sequence c(n) is initialized by using a formula, i.e., cᵢₙᵢₜ is calculated by using the formula.

The formula for initializing the pseudo-random sequence includes the PRS resource number r, i.e., the formula for cᵢₙᵢₜ calculation includes the PRS resource number r. The resource number here may also be known as a resource index or a resource ID.

A formula for initializing the pseudo-random sequence includes a resource index r and a source ID (labeled as SouceID). Further, the formula for initializing the pseudo-random sequence includes SouceID+r×D or SouceID+r. Next, only a situation that the formula for initializing the pseudo-random sequence includes SouceID+r×D is introduced.

r is a PRS resource number, and D is a value that is obtained through high-layer configuration and pre-configuration. A high layer here is a communication protocol layer above a physical layer, which may be, for example, an NAS layer, an RRC layer, an MAC layer, and so on.

The above description provides an overview of this embodiment, and specific examples of this embodiment are then given based on the above description.

A universal pseudo-random sequence is defined by a length-31Gold sequence. A length is an output sequence c(n) of M_{PN}, which is defined by the following when n=0,1, . . . ,M_{PN}−1.

$$c ( n ) = ( {x}_{1} ( n + {N}_{C} ) + {x}_{2} ( n + {N}_{C} ) ) mod 2$$

$${x}_{1} ( n + 31 ) = ( {x}_{1} ( n + 3 ) + {x}_{1} ( n ) ) mod 2$$

$${x}_{2} ( n + 31 ) = ( {x}_{2} ( n + 3 ) + {x}_{2} ( n + 2 ) + {x}_{2} ( n + 1 ) + {x}_{2} ( n ) ) mod 2$$

N_{C}=1600, and a first m sequence x₁(n) is initialized by using x₁(0)=1, x₁(n)=0, n=1,2, . . . ,30. Initialization of a second m sequence x₂(n) is represented by cᵢₙᵢₜ =Σᵢ₌₀³⁰x₂(i)·2ⁱ, and a value depends on the application of the sequence.

UE assumes that a reference signal sequence r(m) is defined by the following formula.

$$r ( m ) = \frac{1}{\sqrt{2}} ( 1 - 2 c ( 2 m ) ) + j \frac{1}{\sqrt{2}} ( 1 - 2 c ( 2 m + 1 ) )$$

The pseudo-random sequence c(n) is defined as described above. A pseudo-random sequence generator should be initialized by using the following formula.

$${c}_{init} = ( {2}^{22} ⌊ \frac{{n}_{ID , seq}^{PRS}}{{2}^{10}} ⌋ + {2}^{10} ( {N}_{symb}^{slot} {n}_{s , f}^{μ} + l + 1 ) ( 2 ( {n}_{ID , seq}^{PRS} mod {2}^{10} ) + 1 ) + ( {n}_{ID , seq}^{PRS} mod {2}^{10} ) ) mod {2}^{31}$$

l is the number of symbols of OFDM within the timeslot, and n_{s,f}^{μ} is the number of timeslots within the frame.

In this embodiment, the formula for initializing the pseudo-random sequence includes SouceID+r×D. That is, a formula for cᵢₙᵢₜ calculation includes SouceID+r×D. More specifically, the formula for cᵢₙᵢₜ calculation includes a variable n_{ID,seq,r}^{PRS}, and the formula for variable n_{ID,seq,r}^{PRS} calculation includes SouceID+r×D, and n_{ID,seq,r}^{PRS}=SouceID+r×D.

N_{ID}^{X} is equal to a decimal of the CRC corresponding to the PSCCH, i.e. N_{ID}^{X}=Σᵢ₌₀^{L-1}pᵢ·2^{L-1-i}. A bit of an effective load is represented as a₀, a₁, a₂, a₃, . . . , a_{A-1}, and a parity bit is represented as p₀, p₁, p₂, p₃, . . ., p_{L-1}, where A is the size of the effective load, and L is the number of parity bits.

The above introduces the method that the first terminal generates the PRS. The first terminal sends the PRS and SCI, and the SCI includes the D value and the SouceID.

A second terminal obtains, by receiving the SCI, the D value and the SouceID indicated by the SCI of the first terminal, and the second terminal determines the resource number r of the PRS by receiving a time-frequency resource position of the PRS. The second terminal receives the PRS sent by the first terminal through the obtained r value, D value, SouceID, etc.

In this embodiment:
the pseudo-random sequence c(n) is configured to generate a PRS sequence r(m).

The pseudo-random sequence c(n) is initialized by using a formula, i.e., cᵢₙᵢₜ is calculated by using the formula.

The formula for initializing the pseudo-random sequence includes a value N_{ID}^{X} that is calculated by CRC. That is, a formula for cᵢₙᵢₜ calculation includes N_{ID}^{X}.

Further, the formula for initializing the pseudo-random sequence includes the value that is calculated by CRC of a PSCCH.

The above description provides an overview of this embodiment, and specific examples of this embodiment are then given based on the above description.

A universal pseudo-random sequence is defined by a length-31Gold sequence. A length is an output sequence c(n) of M_{PN}, which is defined by the following when n=0,1, . . . ,M_{PN}−1.

$$c ( n ) = ( {x}_{1} ( n + {N}_{C} ) + {x}_{2} ( n + {N}_{C} ) ) mod 2$$

$${x}_{1} ( n + 31 ) = ( {x}_{1} ( n + 3 ) + {x}_{1} ( n ) ) mod 2$$

$${x}_{2} ( n + 31 ) = ( {x}_{2} ( n + 3 ) + {x}_{2} ( n + 2 ) + {x}_{2} ( n + 1 ) + {x}_{2} ( n ) ) mod 2$$

N_{C}=1600, and a first m sequence x₁(n) is initialized by using x₁(0)=1,x₁(n)=0,n=1,2, . . . ,30. Initialization of a second m sequence x₂(n) is represented by cᵢₙᵢₜ=Σᵢ₌₀³⁰x₂(i)·2ⁱ, and a value depends on the application of the sequence.

UE assumes that a reference signal sequence r(m) is defined by the following formula.

$$r ( m ) = \frac{1}{\sqrt{2}} ( 1 - 2 c ( 2 m ) ) + j \frac{1}{\sqrt{2}} ( 1 - 2 c ( 2 m + 1 ) )$$

The pseudo-random sequence c(n) is defined as described above. A pseudo-random sequence generator should be initialized by using the following formula.

$${c}_{init} = ( {2}^{22} ⌊ \frac{{n}_{ID , seq}^{PRS}}{1024} ⌋ + {2}^{10} ( {N}_{symb}^{slot} {n}_{s , f}^{μ} + l + 1 ) ( 2 ( {n}_{ID , seq}^{PRS} mod 1024 ) + 1 ) + ( {n}_{ID , seq}^{PRS} mod 1024 ) ) mod {2}^{31}$$

l is the number of symbols of OFDM within a timeslot, and N_{s,f}^{μ} is the number of timeslots within a frame.

In this embodiment, the formula for initializing the pseudo-random sequence includes the value N_{ID}^{X} that is calculated by CRC of the PSCCH. That is, the formula for cᵢₙᵢₜ calculation includes the value N_{ID}^{X} that is calculated by CRC of the PSCCH. More specifically, the formula for cᵢₙᵢₜ calculation includes a variable n_{ID,seq,r}^{PRS}, and the formula for variable n_{ID,seq,r}^{PRS} calculation includes the value N_{ID}^{X} that is calculated by CRC of the PSCCH, and n_{ID,seq,r}^{PRS}=N_{ID}^{X}mod 2¹⁶.

N_{ID}^{X} is equal to a decimal of the CRC corresponding to the PSCCH, i.e. N_{ID}^{X}=Σᵢ₌₀^{L-1}pᵢ·2^{L-1-i}. A bit of an effective load is represented as a₀, a₁, a₂, a₃, . . . , a_{A-1}, and a parity bit is represented as p₀, p₁, p₂, p₃, . . ., p_{L-1}, where A is the size of the effective load, and L is the number of parity bits.

After the first terminal generates the PRS sequence according to the above method, the first terminal sends the PRS, and the PRS is formed after the PRS sequence is mapped to a time-frequency resource.

A second terminal receives the PRS sent by the first terminal.

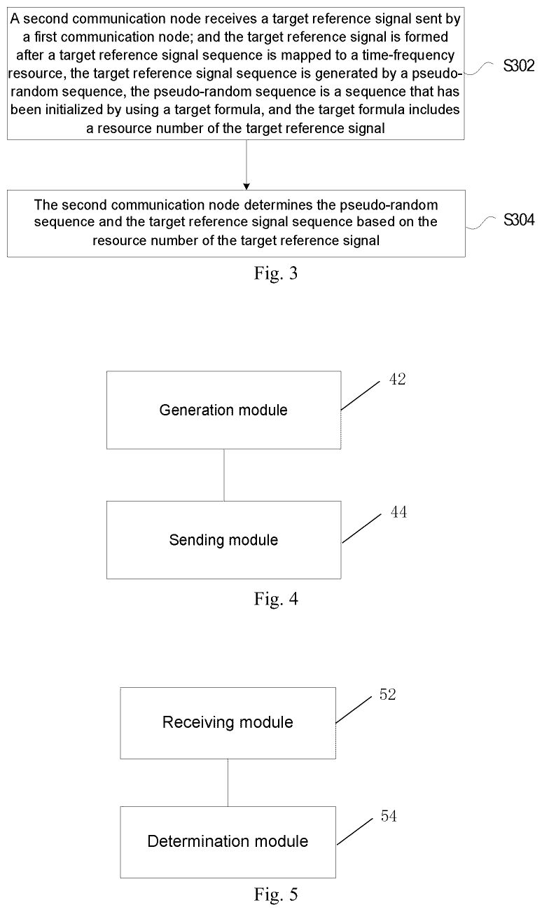

FIG. 3 is a flowchart of a signal receiving method according to an embodiment of the present disclosure. As shown in FIG. 3, the flow includes the following steps.

At S302, a second communication node receives a target reference signal sent by a first communication node; and the target reference signal is formed after a target reference signal sequence is mapped to a time-frequency resource, the target reference signal sequence is generated by a pseudo-random sequence, the pseudo-random sequence is a sequence that has been initialized by using a target formula, and the target formula includes a resource number of the target reference signal.

At S304, the second communication node determines the pseudo-random sequence and the target reference signal sequence based on the resource number of the target reference signal.

In the above embodiment, the target reference signal sequence is a sequence consisting of a series of modulation symbols. The target reference signals are formed after the target reference signal sequence is mapped to the time-frequency resources. The first communication node may send the target reference signal in a unicast, multicast, broadcast, etc. manner.

An execution subject of the steps is the second communication node. The second communication node may be a terminal device.

Through the above embodiment, a formula for generating the target reference signal sequence includes a resource index of the target reference signal, such that a purpose that different reference signal resources use different reference signal sequences is achieved. When a plurality of reference signal resources need to be sent on the plurality of reference signal resources, different reference signal sequences are generated for different reference signal resources through parameters or variables that may be obtained by some sending end without notifying receiving ends through signaling, or the sending ends notify a variable that is the same for a plurality of reference signals, and different reference signal sequences are generated for different reference signal resources through the variable and the parameters or variables that may be obtained by some sending ends without notifying the receiving ends through signaling. Compared to a method of notifying an identifier of each reference signal resource in the related art, by using the solution in the embodiments of the present disclosure, the effect of reducing the sending of resource identifiers and effectively reducing signaling overheads can be achieved, such that the problem of large signaling overheads in the related art is solved.

In an optional embodiment, the target reference signal includes a PRS.

In an optional embodiment, the PRS includes a sidelink PRS.

In an optional embodiment, the target formula includes a product of first data and second data.

The first data includes the resource number, and the second data includes a value that is calculated by CRC corresponding to a target channel.

In an optional embodiment, the target formula includes a sum of first data and second data. The first data includes the resource number, and the second data includes a value that is calculated by CRC corresponding to a target channel.

In an optional embodiment, the target formula includes a product of third data, fourth data, and fifth data. The third data includes the following data: a symbol number of OFDM for sending the reference signal, a timeslot number of a timeslot for sending the reference signal, and the number of symbols of OFDM within the timeslot. The fourth data includes a value that is calculated by CRC corresponding to a target channel, or comprises a source ID of the first communication node. The fifth data includes the resource number.

In an optional embodiment, the target formula includes the predetermined power of 2. The value of the predetermined power is equal to 10−floor(A/2), where Ath power of 2 minus 1 is equal to a maximum value of the resource number, and floor( ) is a downward rounding function.

In an optional embodiment, the target formula includes a variable related to the resource number. The variable corresponding to the resource number with a value being r is obtained by calculating the variable corresponding to the resource number with a value being r−1, where r is a positive integer.

In an optional embodiment, the variable corresponding to the resource number with the value being r is calculated as follows. A product of the variable corresponding to the resource number with the value being r−1 and one positive integer is obtained, and then modulo is performed on the other positive integer.

In an optional embodiment, r≥0, and in a case of r=0, the variable corresponding to the resource number with the value being 0 is calculated through a predetermined formula, and the predetermined formula includes a value that is calculated by CRC corresponding to a target channel.

In an optional embodiment, the target formula includes a resource index of the target reference signal and a source ID of the first communication node.

In an optional embodiment, the target formula includes a product of a resource index of the target reference signal and a predetermined value.

In an optional embodiment, the target formula includes a product of a target sum obtained by adding the resource index of the target reference signal and 1, and the predetermined value.

In an optional embodiment, the method further includes: the second communication node receiving SCI sent by the first communication node. The SCI includes the predetermined value.

In an optional embodiment, the predetermined value is a fixed value.

In an optional embodiment, the predetermined value is a value that is obtained through high-layer configuration and pre-configuration.

In an optional embodiment, the target formula includes a summation value of a product of a resource index of the target reference signal and a predetermined value and a source ID of the first communication node.

In an optional embodiment, the target formula includes a summation value of a resource index of the target reference signal and a source ID of the first communication node.

From the above descriptions about the implementation modes, those skilled in the art may clearly know that the method according to the foregoing embodiments may be implemented in a manner of combining software and a necessary universal hardware platform, and of course, may also be implemented through hardware, but the former is a preferred implementation mode under many circumstances. Based on such an understanding, the technical solutions of the present disclosure substantially or parts making contributions to the conventional art may be embodied in form of software product, and the computer software product is stored in a storage medium (for example, a ROM/RAM), a magnetic disk and an optical disk), including a plurality of instructions configured to enable a terminal device (which may be a mobile phone, a computer, a server, a network device, or the like) to execute the method in each embodiment of the present disclosure.

This embodiment further provides a signal sending apparatus and a signal receiving apparatus. The apparatuses are configured to implement the foregoing embodiments and the preferred implementations, and what has been described will not be described again. As used below, the term “module” may be a combination of software and/or hardware that implements a predetermined function. Although the apparatus described in the following embodiments is preferably implemented in software, but implementations in hardware, or a combination of software and hardware, are also possible and conceived.

FIG. 4 is a structural block diagram of a signal sending apparatus according to an embodiment of the present disclosure. The apparatus may be applied to a first communication node. As shown in FIG. 4, the apparatus includes a generation module and a sending module.

The generation module 42 is configured to generate a target reference signal sequence of target reference signals. The target reference signal sequence is generated by a pseudo-random sequence. The pseudo-random sequence is a sequence that has been initialized by using a target formula. The target formula includes resource numbers of the target reference signals.

The sending module 44 is configured to send the target reference signals. The target reference signals are formed after the target reference signal sequence is mapped to time-frequency resources.

In this embodiment, the target reference signal includes a PRS. Optionally, the PRS includes a sidelink PRS.

Information specifically included in the target formulas in this embodiment and the mode of acquiring the information included in the formula may be found in the foregoing method embodiments, and is not described herein again.

FIG. 5 is a structural block diagram of a signal receiving apparatus according to an embodiment of the present disclosure. The apparatus may be applied to a second communication node. As shown in FIG. 5, the apparatus includes a receiving module and a determination module.

The receiving module 52 is configured to receive a target reference signal sent by a first communication node. The target reference signal is formed after a target reference signal sequence is mapped to a time-frequency resource. The target reference signal sequence is generated by a pseudo-random sequence. The pseudo-random sequence is a sequence that has been initialized by using a target formula. The target formula includes a resource number of the target reference signal.

The determination module 54 is configured to determine the pseudo-random sequence and the target reference signal sequence based on the resource number of the target reference signal.

In this embodiment, the target reference signal includes a PRS. Optionally, the PRS includes a sidelink PRS.

Information specifically included in the target formulas in this embodiment and the mode of acquiring the information included in the formula may be found in the foregoing method embodiments, and is not described herein again.

It is to be noted that, each of the above modules may be implemented by software or hardware. For the latter, it may be implemented in the following manners, but is not limited to the follow: the above modules are all located in a same processor; or the above modules are located in different processors in any combination.

An embodiment of the present disclosure further provides a computer-readable storage medium. The computer-readable storage medium stores a computer program. Steps in any one of the above method embodiments are executed when the computer program is configured to operate.

In an exemplary embodiment, the computer-readable storage medium may include, but is not limited to, a USB flash disk, a Read-Only Memory (ROM), a Random Access Memory (RAM), and various media that can store computer programs, such as a mobile hard disk, a magnetic disk, or an optical disk.

This embodiment of the present disclosure further provides an electronic apparatus. The electronic apparatus includes a memory and a processor. The memory is configured to store a computer program. The processor is configured to run the computer program to execute steps in any one of method embodiments described above.

In an exemplary embodiment, the electronic apparatus may further include a transmission device and an input/output device. The transmission device is connected to the processor. The input/output device is connected to the processor.

For specific examples in this embodiment, refer to the examples described in the foregoing embodiments and the exemplary implementations, and this embodiment will not be repeated thereto.

It is apparent that those skilled in the art should understand that the above-mentioned modules or steps of the present disclosure may be implemented by a general computing device, and may also be gathered together on a single computing device or distributed in network composed of multiple computing devices. The above mentioned modules or steps of the present application may be implemented with program codes executable by the computing device, so that may be stored in a storage device for execution by the computing device, and in some cases, the steps shown or described may be performed in a different sequence than herein, or can be fabricated into individual integrated circuit modules respectively, or multiple modules or steps thereof are fabricated into a single integrated circuit module for implementation. In this way, the present disclosure is not limited to any specific combination of hardware and software.

The above are only the preferred embodiments of the disclosure and are not intended to limit the disclosure. For those skilled in the art, the disclosure may have various modifications and variations. Any modifications, equivalent replacements, improvements and the like made within the principle of the disclosure shall fall within the scope of protection of the present disclosure.

1. A signal sending method, comprising:
generating, by a first communication node, a target reference signal sequence of target reference signals, wherein the target reference signal sequence is generated by a pseudo-random sequence, the pseudo-random sequence is a sequence that has been initialized by using a target formula, and the target formula comprises resource numbers of the target reference signals; and
sending, by the first communication node, the target reference signals, wherein the target reference signal sequence forms the target reference signal after being mapped to a time-frequency resource.

2. The method according to claim 1, wherein the target reference signal comprises a Positioning Reference Signal (PRS).

3. The method according to claim 2, wherein the PRS comprises a sidelink PRS.

4. The method according to claim 1, wherein the target formula comprises a product of first data and second data; and
the first data comprises the resource number, and the second data comprises a value that is calculated by Cyclic Redundancy Check (CRC) corresponding to a target channel;
or, wherein the target formula comprises a sum of first data and second data; and
the first data comprises the resource number, and the second data comprises a value that is calculated by Cyclic Redundancy Check (CRC) corresponding to a target channel;
or, wherein the target formula comprises a product of third data, fourth data, and fifth data;
the third data comprises the following data: a symbol number of Orthogonal Frequency Division Multiplexing (OFDM) for sending the reference signal, a timeslot number of a timeslot for sending the reference signal, and the number of symbols of OFDM within the timeslot;
the fourth data comprises a value that is calculated by CRC corresponding to a target channel, or comprises a source Identification (ID) of the first communication node; and
the fifth data comprises the resource number;
wherein the target formula comprises the predetermined power of 2; and the value of the predetermined power is equal to 10−floor(A/2), wherein 2 to the power of A minus 1 is equal to a maximum value of the resource number, and floor( ) is a downward rounding function.

5. (canceled)

6. (canceled)

7. (canceled)

8. The method according to claim 1, wherein the target formula comprises a variable related to the resource number; and the variable corresponding to the resource number with a value being r is obtained by calculating the variable corresponding to the resource number with a value being r−1, wherein r is a positive integer.

9. The method according to claim 8, wherein the variable corresponding to the resource number with the value being r is calculated as follows:
a product of the variable corresponding to the resource number with the value being r−1 and one positive integer is obtained, and then modulo is performed on the other positive integer;
or, wherein r≥0; and in a case of r=0, the variable corresponding to the resource number with the value being 0 is calculated through a predetermined formula, and the predetermined formula comprises a value that is calculated by CRC corresponding to a target channel.

10. (canceled)

11. The method according to claim 1, wherein the target formula comprises a resource index of the target reference signal and a source ID of the first communication node.

12. The method according to claim 1, wherein the target formula comprises:
a product of a resource index of the target reference signal and a predetermined value;
preferably, wherein the target formula comprises:
a product of a target sum obtained by adding the resource index of the target reference signal and 1, and the predetermined value.

13. (canceled)

14. The method according to claim 12, further comprising:
sending, by the first communication node, Sidelink Control Information (SCI), wherein the SCI comprises the predetermined value;
or, wherein the predetermined value is a fixed value;
or, wherein the predetermined value is a value that is obtained through high-layer configuration and pre-configuration.

15. (canceled)

16. (canceled)

17. The method according to claim 1, wherein the target formula comprises a summation value of a product of a resource index of the target reference signal and a predetermined value and a source ID of the first communication node;
or, wherein the target formula comprises a summation value of a resource index of the target reference signal and a source ID of the first communication node.

18. (canceled)

19. A signal receiving method, comprising:
receiving, by a second communication node, a target reference signal sent by a first communication node, wherein the target reference signal sequence forms the target reference signal after being mapped to a time-frequency resource, the target reference signal sequence is generated by a pseudo-random sequence, the pseudo-random sequence is a sequence that has been initialized by using a target formula, and the target formula comprises a resource number of the target reference signal; and
determining, by the second communication node, the pseudo-random sequence and the target reference signal sequence based on the resource number of the target reference signal.

20. The method according to claim 19, wherein the target reference signal comprises a Positioning Reference Signal (PRS);
preferably, wherein the PRS comprises a sidelink PRS.

21. (canceled)

22. The method according to claim 19, wherein the target formula comprises a product of first data and second data; and
the first data comprises the resource number, and the second data comprises a value that is calculated by Cyclic Redundancy Check (CRC) corresponding to a target channel;
or, wherein the target formula comprises a sum of first data and second data; and
the first data comprises the resource number, and the second data comprises a value that is calculated by Cyclic Redundancy Check (CRC) corresponding to a target channel;
or, wherein the target formula comprises a product of third data, fourth data, and fifth data;
the third data comprises the following data: a symbol number of Orthogonal Frequency Division Multiplexing (OFDM) for sending the reference signal, a timeslot number of a timeslot for sending the reference signal, and the number of symbols of OFDM within the timeslot;
the fourth data comprises a value that is calculated by CRC corresponding to a target channel, or comprises a source Identification (ID) of the first communication node; and
the fifth data comprises the resource number;
or, wherein the target formula comprises the predetermined power of 2; and the value of the predetermined power is equal to 10−floor(A/2), wherein 2 to power of A minus 1 is equal to a maximum value of the resource number, and floor( ) is a downward rounding function;
or, wherein the target formula comprises a variable related to the resource number; and the variable corresponding to the resource number with a value being r is obtained by calculating the variable corresponding to the resource number with a value being r−1, wherein r is a positive integer.

23. (canceled)

24. (canceled)

25. (canceled)

26. (canceled)

27. The method according to claim 22, wherein the variable corresponding to the resource number with the value being r is calculated as follows:
a product of the variable corresponding to the resource number with the value being r−1 and one positive integer is obtained, and then modulo is performed on the other positive integer;
or, wherein r≥0; and in a case of r=0, the variable corresponding to the resource number with the value being 0 is calculated through a predetermined formula, and the predetermined formula comprises a value that is calculated by CRC corresponding to a target channel.

28. (canceled)

29. The method according to claim 19, wherein the target formula comprises a resource index of the target reference signal and a source ID of the first communication node;
or, wherein the target formula comprises:
a product of a resource index of the target reference signal and a predetermined value;
or, wherein the target formula comprises:
a product of a target sum obtained by adding the resource index of the target reference signal and 1, and the predetermined value.

30. (canceled)

31. (canceled)

32. The method according to claim 29, further comprising:
the second communication node receiving Sidelink Control Information (SCI) sent by the first communication node, wherein the SCI comprises the predetermined value;
or, wherein the predetermined value is a fixed value.
or, wherein the predetermined value is a value that is obtained through high-layer configuration and pre-configuration.

33. (canceled)

34. (canceled)

35. The method according to claim 19, wherein the target formula comprises a summation value of a product of a resource index of the target reference signal and a predetermined value and a source identification number of the first communication node;
or, wherein the target formula comprises a summation value of a resource index of the target reference signal and a source identification number of the first communication node.

36. (canceled)

37. A signal sending apparatus, applied to a first communication node and comprising:
a generation module, configured to generate a target reference signal sequence of target reference signals, wherein the target reference signal sequence is generated by a pseudo-random sequence, the pseudo-random sequence is a sequence that has been initialized by using a target formula, and the target formula comprises resource numbers of the target reference signals; and
a sending module, configured to send the target reference signals, wherein the target reference signals are formed after the target reference signal sequence is mapped to time-frequency resources.

38. (canceled)

39. A non-transitory computer-readable storage medium, having a computer program stored therein, wherein the computer program, when being executed by a processor, implements steps of the method according to claim 1.

40. An electronic apparatus, comprising a memory, a processor, and a computer program that is stored in the memory and executable on the processor, wherein the processor, when executing the computer program, implements steps of the method according to claim 1.
